(19) United States
(12) Patent Application Publication
(10) Pub. No.: US 2018/0178606 A1
(43) Pub. Date: Jun. 28, 2018

(54) VEHICLE CAPTURE AND ALIGNMENT SYSTEMS, APPARATUS AND METHOD FOR FLUID, DATA AND/OR POWER TRANSFER

(71) Applicant: Lockheed Martin Corporation, Bethesda, MD (US)

(72) Inventors: Brian R. SAID, Bethesda, MD (US); Nicholas S. ASSEFF, Bethesda, MD (US); Brian N. FISK, Bethesda, MD (US); Stephen M. THOMPSON, Bethesda, MD (US)

(21) Appl. No.: 15/389,737

(22) Filed: Dec. 23, 2016

(51) Int. Cl. B60D 1/62; B63B 27/00

(52) U.S. Cl. CPC B60D 1/62; B63B 27/20

(57) ABSTRACT

Systems, apparatus, and methods for interconnecting two vehicles for the purposes of physical integration, data transfer and/or fluid transfer between the two vehicles. In one example, a system can include a carriage assembly that is deployable from the first vehicle for engagement with the second vehicle. The carriage assembly includes a nesting frame that stabilizes pitch, roll and yaw movements to the second vehicle. A transfer probe assembly is connected to the nesting frame and is deployable together with the nesting frame from the first vehicle. The transfer probe assembly includes a probe that is engageable with the second vehicle at the engaged position and at least one transfer mechanism that can transfer fluid, data, and/or power through the transfer probe assembly between the first vehicle and the second vehicle.

### FIELD

This disclosure relates to interconnecting two vehicles for the purposes of physical integration, and data, power and/or fluid transfer between the two vehicles.

### BACKGROUND

Various systems are known by which two vehicles are aligned along a common axis using human or computer-controlled thrusters and/or other attitude-control effectors independent of each other, with one or both of the vehicles advanced along an axis toward one another until the two vehicles physically contact or engage. One example is spacecraft docking where the zero-gravity or near zero-gravity environment does not subject the two spacecraft to difficult-to-predict and/or difficult-to-compensate-for, and continuously changing, external forces.

Alignment and interconnection of two vehicles in the area of aircraft and seagoing vehicles, including both surface and sub-surface vehicles, is more difficult, where the presence of surface and sub-surface currents, turbulence, wave action, wind effects, and the like complicate the problem of achieving alignment and interconnection. With respect to aircraft and seagoing vehicles, in an ideal situation, one vehicle approaches and aligns itself with the docking interface of the other vehicle and, during that period when alignment is optimum or at least acceptable, is piloted into inter-active engagement. However, the presence of surface and/or subsurface currents, turbulence, waves, and wind acting on the two vehicles can make precise positioning and sustained alignment difficult if not impossible to achieve.

The alignment and interconnection of two vehicles that are in relative motion must address the misalignment along the roll, pitch, yaw, heave, surge and sway axes, and the changes thereof, consequent to the independent movement of one vehicle relative to the other vehicle in three-dimensional space while the two vehicles approach and close the distance therebetween.

### SUMMARY

Systems, apparatus, and methods are described for interconnecting two vehicles for the purposes of physical integration, and fluid, data and/or power transfer between the two vehicles. The techniques described herein reduce a six degree of freedom positioning problem between the two vehicles to merely two degrees of freedom. In addition, the techniques described herein provide a direct physical, but compliant, link between the two vehicles that serves as a physical and signal connection line along which tensile loads are restrained and electro-mechanical and/or fluidic connectors can be guided without complex coordination between control systems of the vehicles. The techniques described herein provide a unique concept of approach, homing, alignment, physical coupling, and transfer connection for fluid/data/energy exchange between two vehicles.

The systems described herein can include a small cursor/carriage assembly that is deployable from a first vehicle for engagement with a subordinate or second vehicle via transit along a tow line (also referred to as a messenger line) engaged in-between. Together, the tow line and cursor/carriage assembly substantially constitute a sub-element that can be referred to as an automated alignment sub-system. The cursor/carriage assembly can include a light weight nesting frame that can register exactly and unambiguously in pitch, roll, yaw, heave, surge, and sway to a receiving node aboard the second vehicle. In one non-limiting embodiment, the cursor/carriage assembly can engage with the second vehicle at its forward end, preferably close to the bow. However, the cursor/carriage assembly can engage with the second vehicle at any location on the second vehicle. The nesting frame and receiving node can form a sub-element referred to as an automated physical connection sub-system. A transfer probe assembly can be embedded in and protected by the nesting frame and that supports couplings for fluid/data/power connection. The transfer probe assembly represents interface connects of sub-system elements for fuel, data and power transfers. A suitable solid mechanical interlock is provided between the transfer probe assembly and a connection socket of the receiving node. Multiple channel transfers for fluid (liquid and/or gas), data, and/or power through the connector transfer sub-systems and along the messenger/tow line can be provided.

The techniques described herein reduce a six degree of freedom positioning problem between the two vehicles to merely two degrees of freedom (x/y positioning to engage the tow line from the first vehicle with a tow line capture structure on the second vehicle). In addition, the direct physical but compliant controlled length of the tow line then links the two vehicles in relative position, which when under tension, supports and guides transit of the cursor/carriage assembly and the nesting frame without complex coordinated control of respective vehicles. Through its transit from the first vehicle to the second vehicle, the cursor/carriage assembly leads cables and/or hoses that translate with the tow line to serve fluid, power, and/or data transfer between the two vehicles. The nesting frame provides at least three zones of contact with the second vehicle receiving node at the engaged position. One contact zone unambiguously fixates roll, surge, heave, and sway of the nesting frame to the second vehicle, while together in combination with the two other contact zones, registration is coordinated in pitch and yaw alignment of the nesting frame to the second vehicle. The nesting frame thereby unifies itself with the pitch, roll, yaw, heave, surge, and sway movements of the second vehicle prior to engaging in its locked position with the second vehicle, resisting accelerations of variable and continuously changing external forces and moments while maintaining compliant support from the taught tow line. The transfer probe assembly then automatically locks in place. Secondary proximity limits and latches can be provided to assure connection integrity prior to fluid/data/power transfer.

The connection system described herein is subject to minimal constraints during the initial part of the acquisition process during that time when misalignments between the two vehicles are largest. The connection system is gradually constrained to incrementally decrease its compliance in a sequential and continuous manner while the second vehicle comes under tow. Under increased drag of the second vehicle, the connection process proceeds, subjecting the cursor/carriage assembly to proportionately and gradually increasing aligning forces and moments as it progresses along the taught tow line carrying the nesting frame, initiating contact with the receiving node of the second vehicle within an acceptance cone of the mating geometries at the interfaces between the nesting frame and the receiving node. During initial contact between the two, misalignments substantially and gradually decrease until the nesting frame is restricted under maximum constraint to the second vehicle during the time that the connection process is near complete. In the final coupling sequence, mechanical connectors pull the mating features closer, driving towards maximum positioning accuracy at the point of intimate unambiguous contact between the transfer probe and an internal connection socket within the receiving node. Once locked together, electrical and/or fluid connectors can be engaged to achieve the desired transfer(s). Connector signal/sealing integrity can be indicated by appropriate sensors prior to commencing fuel/data/power transfer. Disconnect and decoupling of the second vehicle from the first vehicle can proceed substantially in a reverse sequence, with internal disconnect preceding withdrawal of the transfer probe from the internal connection socket, prior to separation of the transfer probe from the receiving node. The cursor/carriage assembly then disengages from the second vehicle, returning along the tow line, following the hose/cabling as the hose/cabling is withdrawn back aboard the first vehicle. Once the cursor/carriage assembly is retrieved aboard the first vehicle, the second vehicle can then disengage from the tow line, at which point the two vessels separate.

The connection between the two vehicles can be used for transfer or exchange between the two vehicles including, but not limited to, one or more of refueling one of the vehicles by the other vehicle, transferring fluids other than fuel, electrically recharging one of the vehicles by the other vehicle, transferring data, and/or any other type of transfer between the vehicles.

The systems, apparatus, and methods described herein provide a technique by which two vehicles can be interconnected while being exposed to conditions of variable and continuously changing external forces and moments. In one non-limiting example, the two vehicles can be maritime vehicles including surface vehicles, submersible vehicles, sub-surface vehicles, and combinations thereof. The interconnection between the two vehicles and fluid, data and/or power transfer between the two vehicles can occur with both vehicles at the surface of the water, both vehicles under the surface of the water, or one vehicle at the surface and one vehicle under the surface. The techniques described herein can be utilized on other types of vehicles including aircraft.

In one embodiment, a carriage assembly is deployable from a first vehicle for engagement with a second vehicle. The carriage assembly includes a nesting frame that defines a receiving area that can receive at least a portion of the second vehicle in an engaged position. The nesting frame provides at least three zones of contact with the second vehicle at the engaged position, and the nesting frame stabilizes pitch, roll, yaw, heave, surge and sway movements to the second vehicle at the engaged position. A transfer probe assembly is connected to the nesting frame and is deployable together with the nesting frame from the first vehicle. The transfer probe assembly includes a probe that is engageable with the second vehicle at the engaged position. In addition, the transfer probe assembly includes at least one transfer mechanism that can transfer fluid, data and/or power through the transfer probe assembly between the first vehicle and the second vehicle.

In another embodiment, a system is deployable from a first vehicle for engagement with a second vehicle. The system includes a tow line (also referred to as a messenger line) that is deployable from the first vehicle and that is engageable with a tow hook on the second vehicle to place the second vehicle under tow. A carriage assembly is connected to the tow line and is movable from a non-deployed position aboard the first vehicle to a deployed position where the carriage assembly is engaged with the second vehicle. The carriage assembly includes a nesting frame that defines a receiving area that receives at least a portion of the second vehicle at the deployed position. The nesting frame provides at least three zones of contact with the second vehicle at the deployed position, and the nesting frame stabilizes pitch, roll, yaw, heave, surge and sway movements to the second vehicle at the deployed position. A transfer probe assembly is connected to the nesting frame. The transfer probe assembly includes a probe that is engaged with the second vehicle at the deployed position. In addition, the transfer probe assembly includes at least one transfer mechanism that can transfer fluid, data and/or power through the transfer probe assembly between the first vehicle and the second vehicle.

A method of capturing and aligning a first vehicle with a second vehicle having a tow hook includes deploying a tow line from the first vehicle, capturing the second vehicle by engaging the tow line with the tow hook to bring the second vehicle under tow by the first vehicle, and deploying the carriage assembly from the first vehicle and engaging the carriage assembly with the second vehicle.

### DRAWINGS

FIG. 1 is a perspective view of a submersible vehicle with which the systems, apparatus and methods described herein can be utilized.

FIG. 2 is top view of a surface vehicle that can be used to capture the submersible vehicle of FIG. 1.

FIG. 3A illustrates a step in the described method with the submersible vehicle surfacing between the trailing tow line.

FIG. 3B illustrates another step in the described method with the tow line engaging the capture hook on the submersible vehicle.

FIG. 3C illustrates still another step in the described method with a carriage assembly being deployed to engage with the submersible vehicle.

FIG. 4 is a top view of the carriage assembly at the beginning of engagement with the submersible vehicle.

FIG. 5 is a side view of the carriage assembly at the beginning of engagement with the submersible vehicle.

FIGS. 6A-C are side views illustrating a sequence of engagement between the carriage assembly and the submersible vehicle.

FIGS. 7A-C are top views illustrating a sequence of engagement between the carriage assembly and the submersible vehicle.

FIG. 8 is a front end view of the submersible vehicle illustrating engagement between the carriage assembly and the submersible vehicle, with the transfer probe assembly removed for clarity.

FIG. 9 is a side view of a front end portion of the submersible vehicle illustrating a transfer interface funnel and a transfer probe of the carriage assembly engaged in the funnel.

FIG. 10 is a front view of the front end portion of the submersible vehicle in FIG. 9 without the transfer probe.

FIG. 11 is a side view illustrating an example of how the transfer probe can be engaged with the transfer interface funnel.

### DETAILED DESCRIPTION

The systems, apparatus, and methods described herein provide a technique by which two vehicles can be interconnected while being exposed to conditions of variable and continuously changing external forces and moments. The connection system is subject to minimal constraints during the initial part of the mutual acquisition process during that time when misalignments are largest. The connection system is gradually constrained to incrementally decrease its compliance in a sequential and continuous manner as the connection process proceeds, subjecting the to-be-connected vehicles to proportionately and gradually increasing aligning forces and moments causing the misalignments to substantially and gradually decrease until such time that the two vehicles are subject to optimal or maximal constraints during the time that the connection process is near complete and then comes to completion, to a level of accuracy and precision required for transfer of, for example, fluids, data and/or power between the vehicles.

In one non-limiting example, the two vehicles can be maritime vehicles that are connected to each other by a tow loop or equivalent type loop-connection that is trailed by one of the vehicles. The tow loop can form a two dimensional are along the sea surface so to engage the other vehicle, or the tow loop can form a two dimensional feature within a near co-planer orientation at a specific depth, determined by the depth from which it is towed. In one embodiment, the tow loop can be made of a material that has a near neutral density relative to the water within which the vehicles are operating. The tow loop may thus engage submersible and/or non-surface (i.e., below the water surface) vehicles.

Once engaged by the tow loop, drag forces on the sub-ordinate vehicle (i.e. the vehicle being towed by the tow loop) will cause the sub-ordinate vehicle to re-align its heading to substantially align with and conform to that of the host vehicle (i.e. the vehicle trailing the tow line), causing loop-connection adjustment relative to the host vehicle until such time that the loop coupling is substantially, if not maximally, tensioned. As the tow loop comes under tension due to drag of the sub-ordinate vehicle, the sub-ordinate vehicle is subject to increasing constraints, thereby reducing its ability to deviate from an acceptable alignment with a carriage assembly that is deployed from the host vehicle using the tow loop, until such time that the sub-ordinate vehicle is contacted by or physically engages with the carriage assembly.

The carriage assembly then sequentially and gradually acquires intimate contact with the sub-ordinate vehicle. The carriage assembly incrementally aligns to and with the sub-ordinate vehicle as the constraints thereon increase between it and the host vehicle with increasing constraint provided by suitable constraining geometric engagement features on the carriage assembly and the sub-ordinate vehicle so as to unambiguously engage to one another. Once the carriage assembly and the sub-ordinate vehicle are suitably engaged, transfer of fluid, data and/or power can take place between the sub-ordinate vehicle and the host vehicle via the carriage assembly.

The release of the sub-ordinate vehicle proceeds substantially in a reverse manner, with the carriage assembly disengaging from the sub-ordinate vehicle and being brought aboard the host vehicle. Once the carriage assembly is disengaged, the sub-ordinate vehicle can then be disengaged from the tow loop, at which point the sub-ordinate vehicle is freed to perform a desired mission.

In the case of maritime vehicles, the maritime vehicles can take the form of for example, sub-surface vehicles, vehicles having both surface and sub-surface and/or above-the-surface capabilities, surface vehicles, watercraft, or amphibious aircraft.

To facilitate an explanation of the concepts described herein, the host vehicle will hereinafter be described and illustrated as a maritime surface vehicle (or just surface vehicle) and the sub-ordinate vehicle will hereinafter be described and illustrated as a submersible vehicle such as an autonomous underwater vehicle or other autonomous watercraft. An autonomous vehicle is a vehicle that does not carry a human operator, and that performs its operations autonomously and is not physically tethered to another vehicle by a mechanical tether during typical operations. The surface vehicle may also be referred to herein as a first vehicle, while the submersible vehicle may also be referred to herein as a second vehicle.

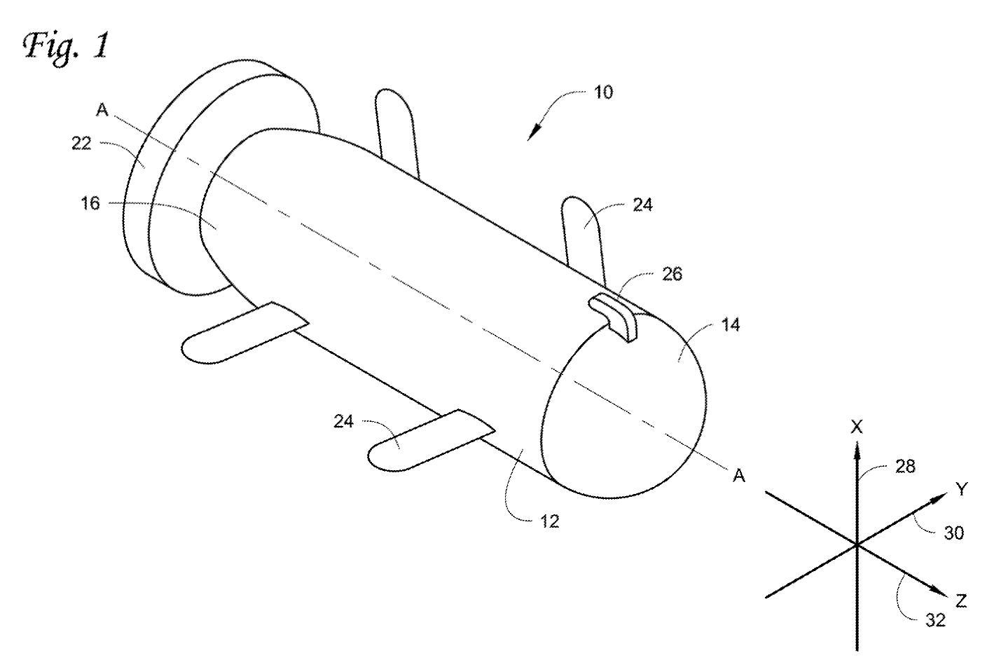

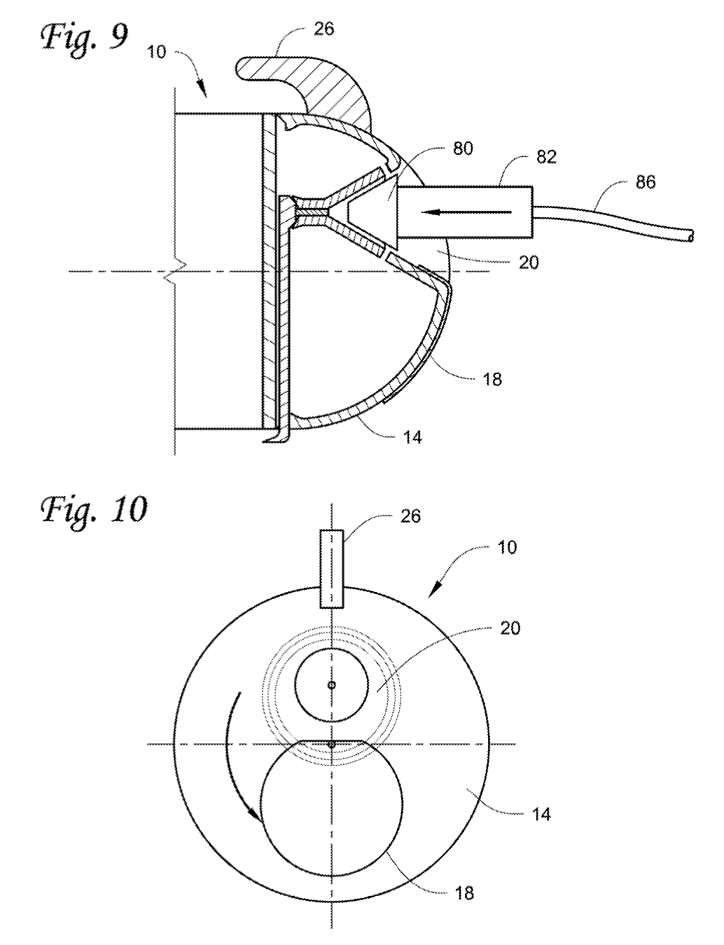

With reference initially to FIG. 1, a submersible vehicle 10 is illustrated. The submersible vehicle 10 can be any type of submersible vehicle that can submerse itself under water, and surface itself so that is disposed at or near the water surface. The submersible vehicle 10 is of generally well-known construction and includes a bull 12, a front end 14, and a rear end 16. The hull 12 can be formed of any materials suitable for underwater use including metals and plastics. The front end 14 is rounded or bullet-shaped for hydrodynamic efficiency. As discussed in further detail below with respect to FIGS. 9-11, the front end 14 includes a movable flap 18 that controllably covers a transfer interface funnel 20 (visible in FIGS. 9-11) of the submersible vehicle 10 through which transfers, including fluid, power and/or data, with the submersible vehicle 10 can occur.

The submersible vehicle 10 further includes any form of suitable propulsion mechanism 22, for example a propeller, which propels the vehicle 10 through the water. Power for the propulsion mechanism 22 can be provided by one or more batteries (not shown) provided within the hull 12 of the vehicle 10. In some embodiments, the batteries can be rechargeable. The vehicle 10 may also include one or more control surfaces 24 for directional control of the vehicle 10 as it travels through the water. Alternatively, the orientation of the propulsion mechanism 22 may be controllable in order to provide directional control.

The vehicle 10 further includes a tow hook 26, alignment rail or other suitable structure provided thereon. The tow hook 26 is suitable for engaging with a tow line (or messenger line) described further below to bring the vehicle 10 under tow during the capture and alignment process described herein.

As illustrated in FIG. 1, when the vehicle 10 is in the water, the front end 14 of the vehicle 10 (as well as the entire vehicle 10 itself) is subject to possible random movements about an X or pitch axis 28, a Y or yaw axis 30, and a Z or roll axis 32, and combinations thereof, due to external forces from, for example, surface and sub-surface currents, turbulence, wave action, wind effects, and the like. The Z axis 32 is coincident with a centerline or center longitudinal axis A-A of the vehicle 10, and the axes 28, 30 are perpendicular to the axis 32.

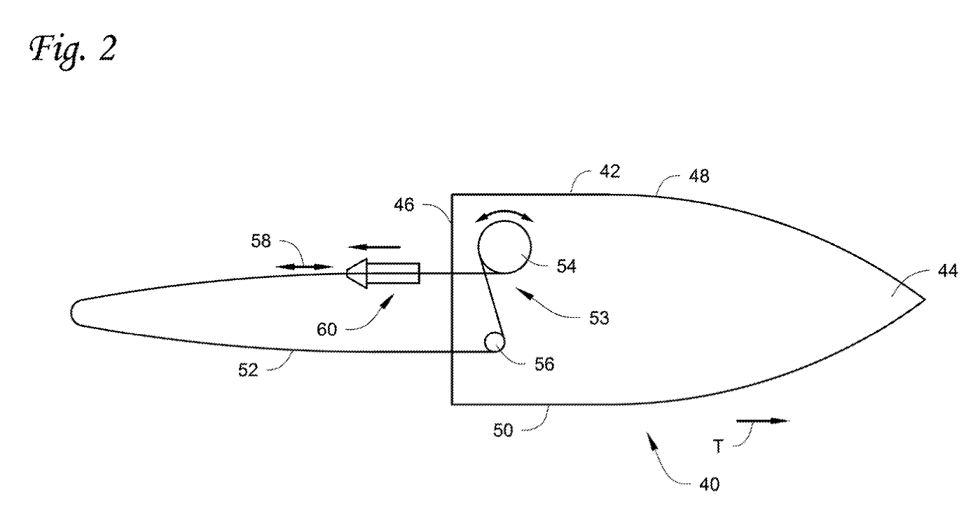

Referring now to FIG. 2, a top view of a surface vehicle 40 that can be used to capture the submersible vehicle 10 of FIG. 1 is illustrated. The surface vehicle 40 includes a hull 42, a bow 44, a stern 46, a port side 48 and a starboard side 50. The vehicle 40 is configured to be able to deploy a tow line 52 into the water for capturing the submersible vehicle 10. In one embodiment, the tow line 52 can be deployed while the vehicle 40 travels through the water in the direction of the arrow T in FIG. 2. The tow line 52 can be deployed from any location of the vehicle 40 into the water including from the bow 44, from the stern 46, from the port side 48, or from the starboard side 50. The tow line 52 can be deployed from the deck of the vehicle 40, or from below the deck above or below the waterline of the hull 42. To aid in describing the concepts herein, the tow line 52 is illustrated in FIG. 2 as being deployed into the water from the stern 46.

The tow line 52 is initially disposed aboard the vehicle 40 and, when capture of the submersible vehicle 10 is required, the tow line 52 can be deployed from the vehicle 40 into the water. The tow line 52 can have any configuration that is suitable for engaging with the submersible vehicle 10 and bringing the vehicle 10 under tow as described further below. The tow line 52 can be, for example, a rope, a cable, or combinations thereof. The tow line 52 is suitable for forming a tow loop when fully deployed that creates a two dimensional arc along the sea surface to facilitate engagement with the vehicle 10. Alternatively, the tow loop formed by the tow line can create a two dimensional arc within a near co-planer orientation at a specific depth under the water surface. In one embodiment, the tow line 52 can be made of a material that has a near neutral density relative to the water within which the vehicles 10, 40 are operating.

As shown in FIG. 2, the vehicle 40 includes a suitable tow line deployment mechanism 53 that is used to deploy the tow line 52 and retract the tow line 52 back aboard the vehicle 40.

In the example illustrated in FIG. 2, the deployment mechanism 53 can include a pair of capstans 54, 56 that are used to control deployment of the tow line 52. At least the capstan 54 is rotatable in both clockwise and counterclockwise directions as indicated by the arrow in FIG. 2 to deploy the tow line 52 from the vehicle 40 or to retract the tow line 52 back aboard the vehicle 40 as indicated by the arrows 58. However, other deployment mechanisms 53 can be used.

Once the tow line 52 is fully deployed, the tow line 52 forms the tow loop in the water behind the stem 46 of the vehicle 40. The forward travel of the vehicle 40 in the direction T helps to maintain the tow loop of the tow line 52 for capturing the vehicle 10.

Still referring to FIG. 2, a carriage assembly 60 is also deployable from the vehicle 40. The carriage assembly 60 is configured to engage with the vehicle 10 to help stabilize the vehicle 40 about the pitch, roll, and yaw axes 28-32 (as well as in heave, surge, and sway), and once engaged facilitate fluid, power and/or data transfer with the vehicle 10. Further details of the carriage assembly 60 are described below. The carriage assembly 60 is initially in a non-deployed position where the carriage assembly is aboard the vehicle 40. The carriage assembly 60 can be deployed from the non-deployed position to a deployed position where the carriage assembly 60 is fully engaged with the vehicle 10.

In the example illustrated in FIG. 2, the carriage assembly 60 is deployed using the tow line 52. In one embodiment, which is described in further detail below, the carriage assembly 60 can be fixed to the tow line 52 so that the carriage assembly 60 moves with the tow line 52 as the tow line 52 moves. In another embodiment, the carriage assembly 60 can be disposed on, but move relative to, the tow line 52 to the deployed position. For example, once the tow line 52 is deployed, the carriage assembly 60 can be deployed by freely sliding down the tow line 52 to the deployed position via gravity; a drive mechanism can be provided that mechanically drives the carriage assembly 60 on the tow line 52 between the non-deployed and deployed positions; or if the tow line 52 is disposed in the water, the force of the water acting on the carriage assembly 60 as the vehicle 40 travels through the water can cause the carriage assembly 60 to move to the deployed position. However, any technique for causing the carriage assembly 60 to be moved to the deployed position via the tow line 52 can be used.

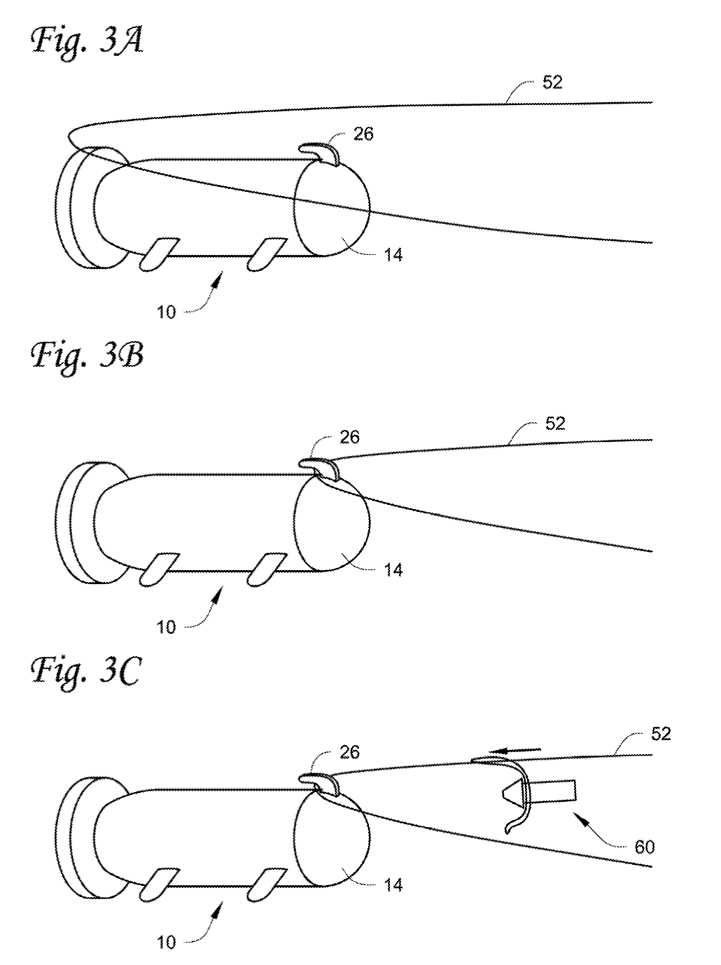

Referring to FIGS. 3A-3C, an example of initial steps in a method of capturing, stabilizing, and aligning the submersible vehicle 10 are illustrated. Referring to FIG. 3A, the vehicle 40 (shown in FIG. 2) deploys the tow line 52 to form the tow loop as the vehicle 40 travels in the direction T towing the tow line 52 behind the vehicle 40. In this example, it is assumed that the tow line 52 is floating at the water surface. Using its propulsion mechanism 22 and its control surface(s) 24, the vehicle 10 properly positions itself and surfaces within the area of the tow loop of the trailing tow line 52.

Referring to FIG. 3B, once within the tow loop area, the vehicle 10 then slows down and/or stops relative to the vehicle 40. As the vehicle 40 continues to travel forwardly, the tow line 52 snags the tow hook 26 to bring the vehicle 10 under tow. Once the tow line 52 is engaged with the tow hook 26, the carriage assembly 60 is then deployed using the tow line 52 as shown in FIG. 3C. In an embodiment where the carriage assembly 60 is fixed to the tow line 52, the carriage assembly 60 is deployed by advancing the tow line 52 in the direction of the arrow shown in FIG. 3C. The tow line 52 continues to be advanced until the carriage assembly 60 engages with the front end 14 of the vehicle as discussed further below. Engagement between the carriage assembly 60 and the front end 14 stabilizes the front end 14 about the pitch, roll, and yaw axes 28-32 (as well as in heave, surge, and sway), and once stabilized, fluid, power and/or data transfer with the vehicle 10 can occur through the carriage assembly.

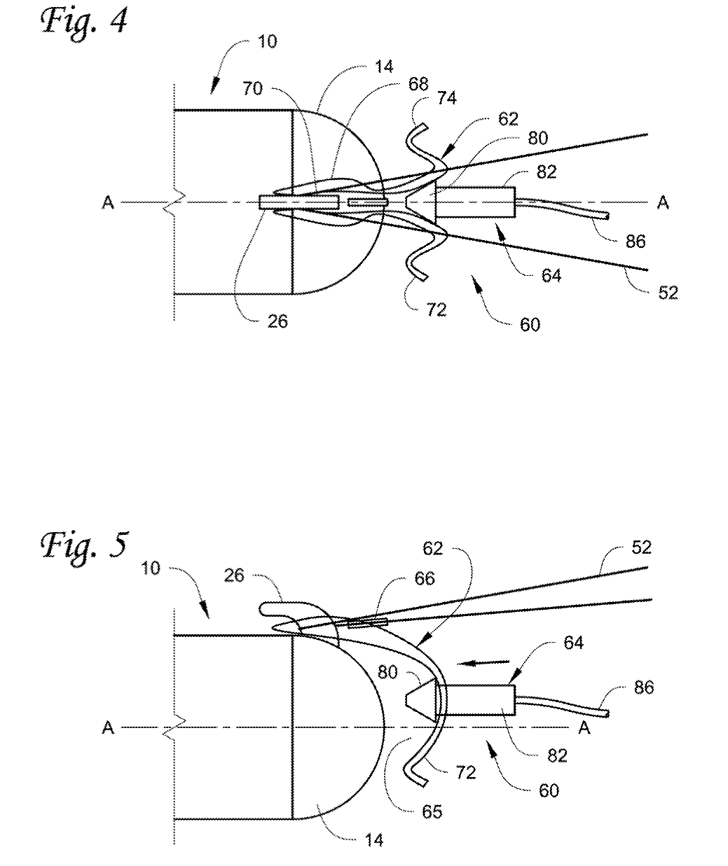

The carriage assembly 60 can have any configuration that is suitable for engaging with the vehicle 10 to stabilize the vehicle 10 and through which fluid, power and/or data transfer with the vehicle 10 can occur. An example of the carriage assembly 60 is illustrated in FIGS. 4 and 5 that is configured to engage with and stabilize the front end 14 of the vehicle 10 about the pitch, roll and yaw axes 28-32 (as well as in heave, surge, and sway). However, other carriage assembly 60 constructions that engage with and stabilize other portions of the vehicle 10 can be utilized.

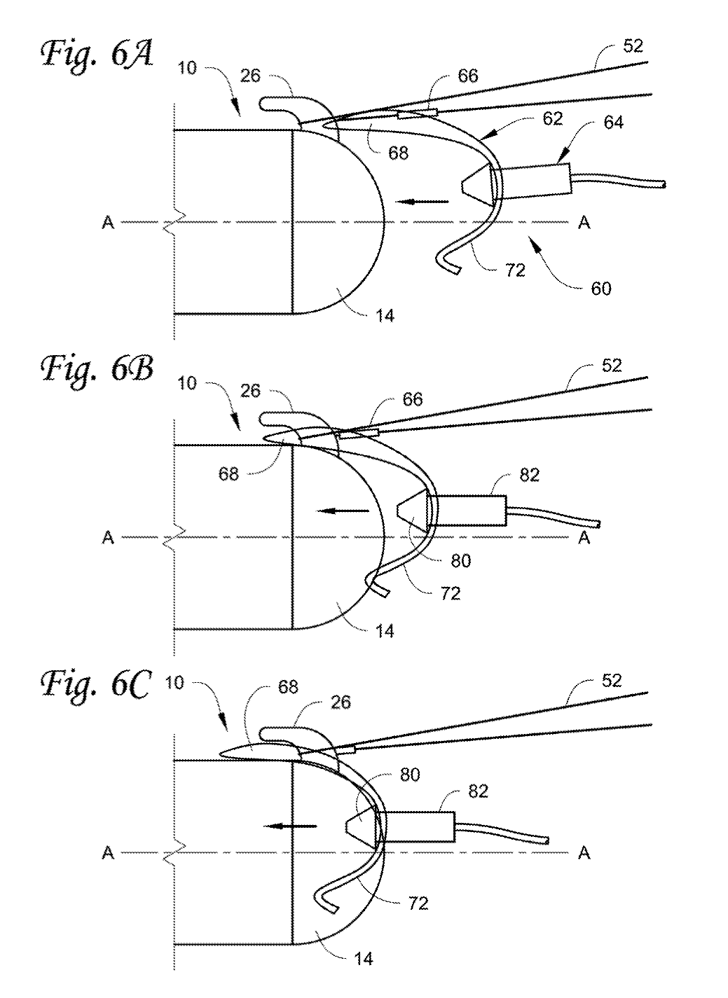

In the example illustrated in FIGS. 4-5, the carriage assembly 60 includes a nesting frame 62 and a transfer probe assembly 64 connected to the nesting frame 62. The nesting frame 62 defines a concave receiving area 65 that can receive at least a portion of the front end 14 of the vehicle 10 in an engaged position (shown in FIG. 6C). The nesting frame 62 is configured to provide at least three points of contact (or contact zones) with the front end 14 of the vehicle 10 at the engaged position, such that in the engaged position, the nesting frame 62 stabilizes pitch, roll and yaw movements to the front end 14 of the vehicle 10. In addition, in the illustrated embodiment, the nesting frame 62 is flexibly fixed to the tow line 52 by a suitable fixation joint 66 so that the carriage assembly 60 moves together with the tow line 52. Therefore, in this embodiment, movement of the tow line 52 in one direction is used to bring the nesting frame 62 into engagement with the front end 14 of the vehicle 10, while movement of the tow line 52 in the opposite direction is used to disengage the nesting frame 62 from the front end 14 of the vehicle 10.

The nesting frame 62 can have any configuration that stabilizes the front end 14 of the vehicle 10 when the nesting frame 62 is at the engaged position. For example, in the illustrated embodiment, the nesting frame 62 has at least three arms (also referred to as contact effectors since the arms effect contact with the front end 14 of the vehicle 10). A first one of the arms 68 is at the top of the nesting frame 62 and is fixed to the tow line 52 by the fixation joint 66. The arm 68 defines a longitudinally extending slot 70 that is open at its forward end and that coincides with the longitudinal axis A-A of the vehicle 10. The slot 70 receives the tow hook 26 or the alignment rail on the vehicle 10 helping to guide the nesting frame 62 into proper position on the front end 14 as the nesting frame 62 moves into engagement with the front end 14. At the engaged position of the nesting frame 62, the tow hook 26 or alignment rail is received in the slot 70.

The nesting frame 62 further includes two additional arms 72, 74. The arms 72, 74 are located below the first arm 68, extend downwardly from the first arm 68, and are disposed on opposite sides of the longitudinal axis A-A of the vehicle 10. As best seen in FIG. 5, the arms 72, 74 are curved in a direction away from the vehicle 10 to define the receiving area 65 that receives the front end 14. In addition, as best seen in FIG. 4, the arms 72, 74 extend away from one another on opposite sides of the axis A-A.

Referring to FIGS. 4-5, in the illustrated example of the nesting frame 62, the arm 68 forms at least one first point (or zone) of contact with the vehicle 10, where the first point of contact is disposed along the longitudinal axis A-A (see FIG. 4) and above the axis A-A (see FIGS. 5 and 6C) at the engaged position. The arm 72 forms at least one second point (or zone) of contact with the vehicle 10, where the second point of contact is spaced from the longitudinal axis A-A on a first side thereof (see FIG. 4) and is below the longitudinal axis A-A (see FIGS. 5 and 6C) at the engaged position. In addition, the arm 74 forms at least one third point (or zone) of contact with the vehicle 10, where the third point of contact is spaced from the longitudinal axis A-A on a second thereof (see FIG. 4) and is below the longitudinal axis A-A (see FIGS. 5 and 6C) at the engaged position. Due to the at least three zones of contact between the nesting frame 62 and the vehicle 10 when the nesting frame 62 is at the engaged position, the front end 14 of the vehicle 10 is stabilized to the nesting frame 62 about the pitch axis 28, the yaw axis 30, and the roll axis 32.

With continued reference to FIGS. 4 and 5, the transfer probe assembly 64 is fixed to the nesting frame 62 and is movable together with the nesting frame 62. The transfer probe assembly 64 includes a probe 80 that is engageable with the front end 14 of the vehicle 10 at the engaged position of the nesting frame 62. As with the nesting frame 62, movement of the tow line 52 in one direction is used to bring the transfer probe assembly 64 into engagement with the front end 14 of the vehicle 10, while movement of the tow line 52 in the opposite direction is used to disengage the transfer probe assembly 64 from the front end 14 of the vehicle 10.

In the illustrated example, the probe 80 is frusto-conical in shape and is arranged to be disposed within the transfer interface funnel 20 at the engaged position (discussed further below with respect to FIG. 9). In another embodiment, the probe 80 can define asymmetrical cross-sections of tapering geometry along a longitudinal axis thereof. The probe 80 is disposed between the two arms 72, 74 so that in a top view, a longitudinal axis of the probe 80 is substantially parallel to and coincides with the longitudinal axis A-A (see FIG. 4). A probe body 82 extends rearwardly from the probe 80.

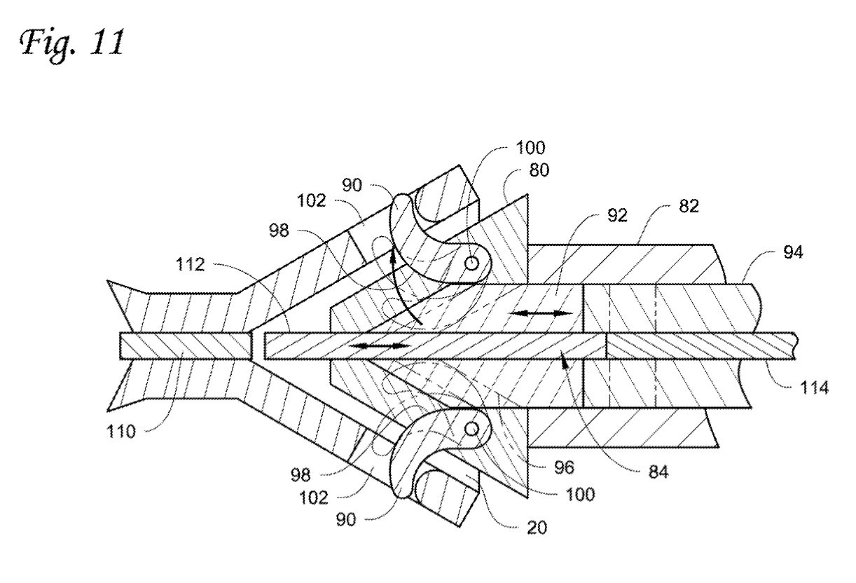

Referring to FIG. 11, one or more fluid and/or data and/or power transfer mechanisms 84 extend through the probe 80 and the probe body 82. The transfer mechanism(s) 84 transfers fluid, for example a liquid fuel, and/or data and/or electrical power through the transfer probe assembly 64 between the vehicle 10 and the vehicle 40. The transfer of fluid, data and/or power can be from the vehicle 40 to the vehicle 10, from the vehicle 10 to the vehicle 40, or both. Referring again to FIGS. 4 and 5, one or more umbilicals 86 extend from the probe body 82 back to the vehicle 40 through which suitable conduits for the fluid, data and/or power transfer extend back to the vehicle 40. The umbilical(s) 86 travels with the transfer probe assembly 64 as it is deployed from the vehicle 40 and brought back aboard the vehicle 40.

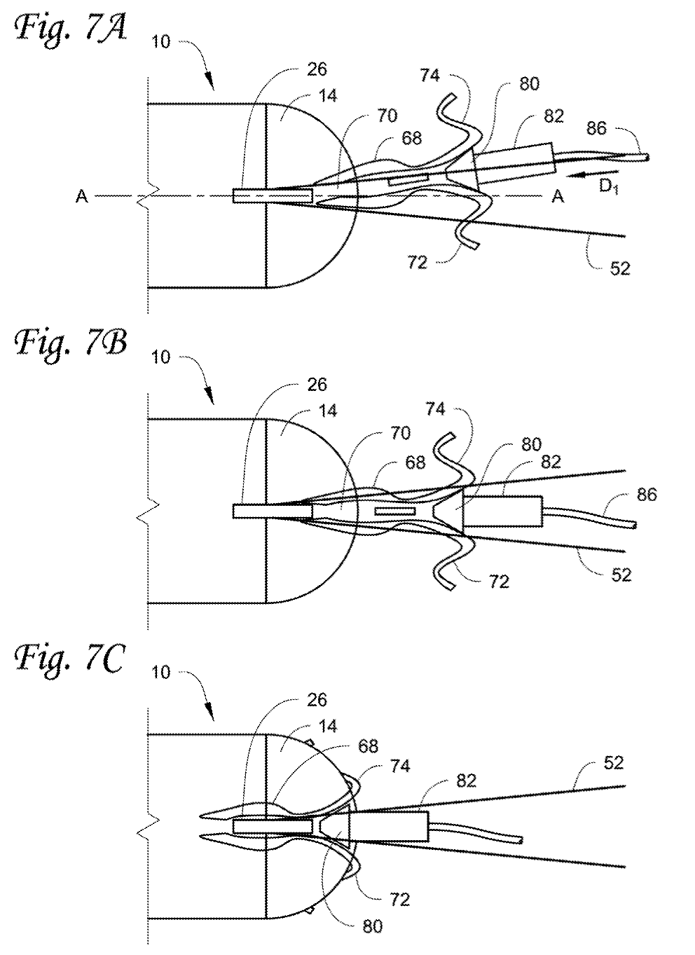

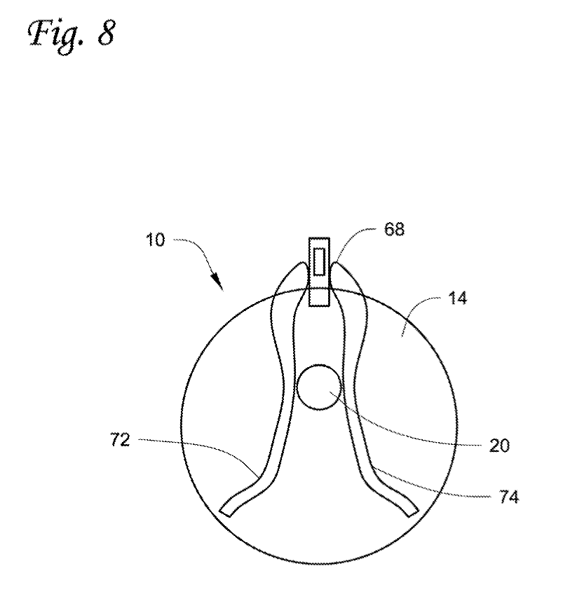

Referring now to FIGS. 6A-C, 7A-C and 8, a sequence of engagement between the carriage assembly 60 and the vehicle 10 will now be described. As described above with respect to FIGS. 3A-C, once the vehicle 10 is brought under tow by the tow line 52, the carriage assembly 60 is deployed from the vehicle 40. In the illustrated example, the carriage assembly 60 is deployed by advancing the tow line 52 in the direction of the arrow DI (seen in FIG. 7A) using the deployment mechanism 53 on the vehicle 40 (FIG. 2). Since the carriage assembly 60 is fixed to the tow line 52, the carriage assembly 60 advances with the tow line 52. As the tow line 52 is advanced, the tow line 52 slides along the tow hook 26 with the other end of the tow line 52 being wound up on the deployment mechanism 53.

As best seen in FIGS. 7A and 7B, as the carriage assembly 60 nears the front end 14 of the vehicle 10, the slot 70 in the arm 68 of the nesting frame 62 becomes aligned with the tow hook 26 and further advancement of the carriage assembly 60 causes the tow hook 26 to enter the slot 70. This helps to align the rest of the nesting frame 62 with the front end 14 of the vehicle 10. Continued advancement of the carriage assembly 60 by the tow line 52 causes the front end 14 of the vehicle 10 to enter into the concave receiving area 65 of the nesting frame 62, until the arms 72, 74 engage the front end 14 (FIGS. 6C and 7C) on opposite sides of the longitudinal axis A-A.

In one embodiment as shown in FIG. 6B, the arms 68, 72, 74 become engaged with and stabilize the front end 14 before the transfer probe assembly 64 begins engaging the front end 14 to ensure a more reliable connection for any subsequent transfer of fluid, data and/or power. However, once the arms 68, 72, 74 become engaged with the front end 14, the transfer probe 80 can enter into the transfer interface funnel 20 in the front end 14 as the nesting frame 62 completes its engagement with the front end 14.

Referring to FIGS. 9 and 10, the front end 14 of the vehicle 10 includes the movable flap or cover 18 that controllably covers the transfer interface funnel 20. The flap 18 is moveable from a first, closed position (not shown) where it covers the transfer interface funnel 20 and a second, open position (FIGS. 9 and 10) where the funnel 20 is not covered and the transfer probe 80 can access the funnel 20. The flap 18 can be moved to the open position whenever access to the transfer interface funnel 20 is desired, for example prior to the carriage assembly 60 engaging with the front end 14. In one embodiment, the movements of the flap 18 can be controlled by a suitable actuator on the vehicle 10. In another embodiment, the movements of the flap 18 can be achieved manually, for example by a diver. In another embodiment, once the vehicle 10 is under positive tow, some of the drag force could be used to actuate the flap 18 to the open position.

Once the transfer probe 80 enters into the transfer interface funnel 20, a probe locking mechanism can be actuated to secure the probe 80 to the funnel 20. Any form of actuatable locking mechanism that can secure the probe 80 within the funnel 20 and that can be disengaged to allow release of the probe 80 can be used. FIG. 11 illustrates one non-limiting example of a probe locking mechanism. However, many other forms of probe locking mechanism can be utilized.

In the example illustrated in FIG. 11, the probe 80 includes a plurality, for example two or more, of hooks 90 that are pivotally mounted to the probe 80 for pivoting movement between a retracted position within the probe 80 (shown in dashed lines in FIG. 11) and a latching position (shown in solid lines in FIG. 11). A cam 92 is disposed within the probe 80 and the probe body 82 that can be actuated by a suitable cam actuator 94 in forward and reverse directions as indicated by the double headed arrow in FIG. 11. The cam 92 includes an actuating surface 96 (illustrated in dashed lines) that is engaged with surfaces 98 of the hooks 90. The surfaces 98 of the hooks 90 ride on the actuating surface 96, and as the cam 92 is actuated in a direction toward the vehicle 10 (or to the left in FIG. 11), the hooks 90 are forced to pivot outwardly to the latching position about pivot axes 100. Likewise, as the cam 92 is actuated in a direction away from the vehicle 10 (or to the right in FIG. 11), the hooks 90 pivot inwardly back to the retracted position. If necessary, the hooks 90 can be biased, for example by one or more springs, toward the retracted position.

In addition, the funnel 20 includes slots 102 formed therein that can receive the non-pivoted ends of the hooks 90 when the hooks 90 are at the latching position. Actuating the hooks 90 into engagement with the slots 102 releasably locks the probe 80 within the funnel 20. Many other locking mechanisms are possible, including arrangements where the hooks are provided on the funnel 20 and the slots 102 are formed in the probe 80.

In some embodiments, for example when a liquid such as fuel is to be transferred, the transfer probe assembly 64 can also include an actuator that can actuate open a valve 110, such as a wet mate connector, on the vehicle 10 before the liquid can flow. For example, in one non-limiting example and with reference to FIG. 11, the transfer probe assembly 64 can include a quill 112 that can be actuated by a quill actuator 114 in forward and reverse directions as indicated by the double headed arrow in FIG. 11. The quill 112 can be actuated in a direction toward the vehicle 10 (or to the left in FIG. 11), which causes the end of the quill 112 to engage the valve 110 and open the valve 110. Likewise, as the quill 112 is actuated in a direction away from the vehicle 10 (or to the right in FIG. 11), the quill 112 disengages from the valve 110 and the valve 110 closes.

In some embodiments, the quill 112 can be hollow in which case fluid, data and/or power to be transferred can flow through the quill 112 to and/or from the vehicle 10. In other embodiments, fluid to be transferred can flow through the quill 112 while data and/or power can be transferred via other interfaces. In still other embodiments, data and/or power to be transferred can flow through the quill 112 while fluid can be transferred via another interface. Many other variations for achieving transfer of fluids, data and/or power are possible and can be utilized.

The fluid to be transferred between the vehicles 10, 40 can be fuel. In one embodiment, the fuel can be transferred from the vehicle 40 to the vehicle 10 for refueling the vehicle. In another embodiment, the fuel can be transferred from the vehicle 10 to the vehicle 40 for draining remaining fuel from the vehicle 10, for example prior to recovering the vehicle 10 by bringing the vehicle 10 onboard the vehicle 40.

Data can be transferred electrically and/or optically between the vehicles 10, 40. In one embodiment, data can be transferred from the vehicle 10 onto the vehicle 40, for example at an end of a mission of the vehicle 10. The data can be sensory data that has been collected by one or more sensors onboard the vehicle 10. In another embodiment, data can be transferred from the vehicle 40 into the vehicle 10, for example programming the vehicle 10 for a new mission. In still another embodiment, data can be transferred from the vehicle 10 to the vehicle and from the vehicle 40 to the vehicle 10. Many other forms of data transfer can be utilized, as well as many other types of data can be transferred.

In the case of power transfer, electrical power can be transferred from the vehicle 40 into the vehicle 10 for recharging one or more rechargeable batteries on the vehicle 10.

With the construction described herein, the nesting frame provides initial gross alignment with the vehicle 10 with minimum parts and isolation from the tow line 52 by being located as far aft as possible on the tow line 52 with the flexible joint 66. The probe 80 achieves precision alignment with the front end 14 of the vehicle 10, and the quill 112 achieves the final connection.

With the construction described herein, pitching of the front end 14 of the vehicle 10 along the pitch axis 28 is resisted by close fitting nesting frame 62 providing positive pitch moment, while keying of the nesting frame 62 and the tow hook 26 via the slot 70 provides negative pitch moment by lever arm section extending aft of the tow hook 26. The nesting frame 62 is flexibly attached to the tow line 52 as close to the tow hook 26 as possible.

With the construction described herein, rolling of the front end 14 of the vehicle 10 about the roll axis 32 is resisted by the keying between the nesting frame 62 and the tow hook 26 via the slot 70, and the constraint across the vertical distance between the tow hook 26 and the nesting frame 62 on the front end 14.

With the construction described herein, side to side yawing of the front end 14 of the vehicle 10 along the yaw axis 30 is resisted by the vertical axis flex joint 66 just forward of the keying between the nesting frame 62 and the tow hook 26 via the slot 70, and the double arms 72, 74 of the nesting frame 62.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A carriage assembly deployable from a first vehicle for engagement with a second vehicle, comprising:
a nesting frame that defines a receiving area that can receive at least a portion of the second vehicle in an engaged position, the nesting frame providing at least three zones of contact with the second vehicle at the engaged position, and the nesting frame stabilizes pitch, roll and yaw movements to the second vehicle at the engaged position;
a transfer probe assembly connected to the nesting frame and deployable together with the nesting frame from the first vehicle, the transfer probe assembly includes a probe that is engageable with the second vehicle at the engaged position; and
the transfer probe assembly includes at least one transfer mechanism that can transfer fluid, data and/or power through the transfer probe assembly between the first vehicle and the second vehicle.

2. The carriage assembly of claim 1, wherein the nesting frame has at least three contact effectors; a first one of the contact effectors forms a longitudinal slot that coincides with a longitudinal axis of the second vehicle and that can receive a tow hook or alignment rail on the second vehicle at the engaged position; the other two contact effectors are located adjacent to the first contact effector and are disposed on opposite sides of the longitudinal slot.

3. The carriage assembly of claim 2, wherein the probe is disposed between the other two contact effectors.

4. The carriage assembly of claim 1, wherein the probe is frusto-conical in shape.

5. The carriage assembly of claim 1, wherein the probe defines asymmetrical cross-sections of tapering geometry along a longitudinal axis thereof.

6. A system that is deployable from a first vehicle for engagement with a second vehicle, comprising:
a tow line that is deployable from the first vehicle and that is engageable with a tow hook on the second vehicle to place the second vehicle under tow;
a carriage assembly that is connected to the tow line and that is movable from a non-deployed position aboard the first vehicle to a deployed position where the carriage assembly is engaged with the second vehicle, the carriage assembly including:
a nesting frame that defines a receiving area that receives at least a portion of the second vehicle at the deployed position, the nesting frame providing at least three zones of contact with the second vehicle at the deployed position, and the nesting frame stabilizes pitch, roll and yaw movements to the second vehicle at the deployed position;
a transfer probe assembly connected to the nesting frame, the transfer probe assembly includes a probe that is engaged with the second vehicle at the deployed position; and
the transfer probe assembly includes at least one transfer mechanism that can transfer fluid, data, and/or power through the transfer probe assembly between the first vehicle and the second vehicle.

7. The system of claim 6, wherein the nesting frame has at least three contact effectors; a first one of the contact effectors forms a longitudinal slot that coincides with a longitudinal axis of the second vehicle and that receives the tow hook or an alignment rail on the second vehicle at the deployed position; the other two contact effectors are located are located adjacent to the first contact effector and are disposed on opposite sides of the longitudinal slot.

8. The system of claim 7, wherein the probe is disposed between the other two contact effectors.

9. The system of claim 6, wherein the probe is frusto-conical in shape.

10. The system of claim 6, wherein the probe defines asymmetrical cross-sections of tapering geometry along a longitudinal axis thereof.

11. The system of claim 6, wherein the carriage assembly is mounted on the tow line, and the carriage assembly is movable from the non-deployed position to the deployed position by moving with the tow line.

12. The system of claim 6, wherein the first vehicle is a maritime surface vessel and the second vehicle is an autonomous watercraft.

13. A method of capturing and aligning a first vehicle with a second vehicle having a tow hook, comprising:
deploying a tow line from the first vehicle;
capturing the second vehicle by engaging the tow line with the tow hook to bring the second vehicle under tow by the first vehicle; and
deploying a carriage assembly from the first vehicle and engaging the carriage assembly with the second vehicle; the carriage assembly includes a nesting frame that defines a receiving area that receives at least a portion of the second vehicle, the nesting frame providing at least three zones of contact with the second vehicle to stabilize pitch, roll and yaw movements to the second vehicle, and a transfer probe assembly connected to the nesting frame and deployable together with the nesting frame from the first vehicle, the transfer probe assembly includes a probe that is engaged with the second vehicle, and at least one transfer mechanism that can transfer fluid, data and/or power through the transfer probe assembly between the first vehicle and the second vehicle.

14. The method of claim 13, comprising mounting the carriage assembly on the tow line, and deploying the carriage assembly comprises moving the tow line which moves the carriage assembly into engagement with the second vehicle.

15. The method of claim 13, wherein the first vehicle is a maritime surface vessel and the second vehicle is an autonomous watercraft.
